(19) United States
(12) Patent Application Publication
(10) Pub. No.: US 2006/0259623 A1
(43) Pub. Date: Nov. 16, 2006

(54) PROXY FOR ENABLING COMMUNICATION BETWEEN MOBILE DEVICE AND GAME SERVICE

(75) Inventors: Lee Crawford, Los Altos, CA (US); John Cahill, Spring Lake Heights, NJ (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/383,178

(22) Filed: May 12, 2006

Related U.S. Application Data
(60) Provisional application No. 60/681,202, filed on May 13, 2005.

(51) Int. Cl. G06F 15/173

(52) U.S. Cl. 709/226

(57) ABSTRACT

A system and method are directed towards managing communication with an online service on behalf of a device that may have intermittent communication. A proxy server provides a reliable communication session with the online service, such as a game service, and relays information between the online service and an intermittent communication device, such as a mobile terminal. The proxy server stores messages and/or other information from the online service while the intermittent communication device is not communicating with the proxy server. The proxy server may manage the communication upon request from the intermittent communication device, the online service, or from another source such as a portal with which the intermittent communication device communicates. The proxy server uses a table of unique identifiers to map messages between multiple intermittent communication devices and one or more online services. Proxy communication may terminate after a command or an elapsed time of interrupted communication.

### CROSS-REFERENCE TO RELATED APPLICATIONS

This application claims the benefit of U.S. Provisional Application, titled “Proxy for Enabling Communication Between Mobile Device and Game Service,” Ser. No. 60/681,202 filed on May 13, 2005, the benefit of the earlier filing date of which is hereby claimed under 35 U.S.C. § 119(e), and further is incorporated by reference.

### FIELD OF THE INVENTION

The present invention relates generally to multi-person online services, and more particularly, but not exclusively, to managing communication with an online service on behalf of a device that may have intermittent communication.

### BACKGROUND OF THE INVENTION

Online multiplayer games and other collaboration services have become increasingly popular as network communications have improved. Users who may be geographically distant from each other may communicate with an online service to participate together in games and/or other collaboration services. Typically, users run a client program that performs local processing and communicates with the online service to coordinate joint state of the multi-user game or service. For users to initiate participation in the same online game or online service, users may meet in an online lobby or other matching system that is associated with the online game or online service. However, if a person is not already communicating with the same lobby, or already participating in the same online service, the person may not be aware that a friend or colleague is participating. The friend or colleague can manually telephone the person or send a message with an identifier to invite the person to participate in the same online game or service. To reach people outside of the online game service, a message is typically sent through an independent messaging service, such as an online portal email service or instant message service, which is generally not limited to registered users of the online game service. However, this out-of-band messaging may be time consuming to find contact information and may distract from a current game session or other service session.

Mobile devices are also being used to participate in online games. In addition to the difficulties of informing others of a mobile user's participation in an online service, a mobile device may have more difficulty maintaining consistent communication with the online service. Communication may be interrupted during transition between mobile cells. Communication quality and/or speed may also be affected by jitter, atmospheric conditions, and other factors. Consequently, online sessions may be dropped, slowed, or otherwise degraded.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client mobile device that may be included in a system implementing the invention;

FIG. 3 shows one embodiment of a proxy server that may be included in a system implementing the invention;

FIG. 4 is a flow diagram illustrating exemplary logic for one embodiment of a game probe to detect execution of a game program and notify another client; and

FIG. 5 is a flow diagram illustrating exemplary logic for one embodiment of a proxy server process for managing communication between a client mobile device and an online service.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely software embodiment, an entirely hardware embodiment or an embodiment combining software and hardware aspects. The following detailed description is, therefore, not to be taken in a limiting sense. Briefly stated, the present invention is directed towards managing communication with an online service on behalf of a device that may have intermittent communication. Although the invention is not so limited, an exemplary embodiment is described below in terms of a client mobile device executing a game program to participate in an online game system, and a proxy system that may or may not be directly associated with the online game system.

Illustrative Operating Environment

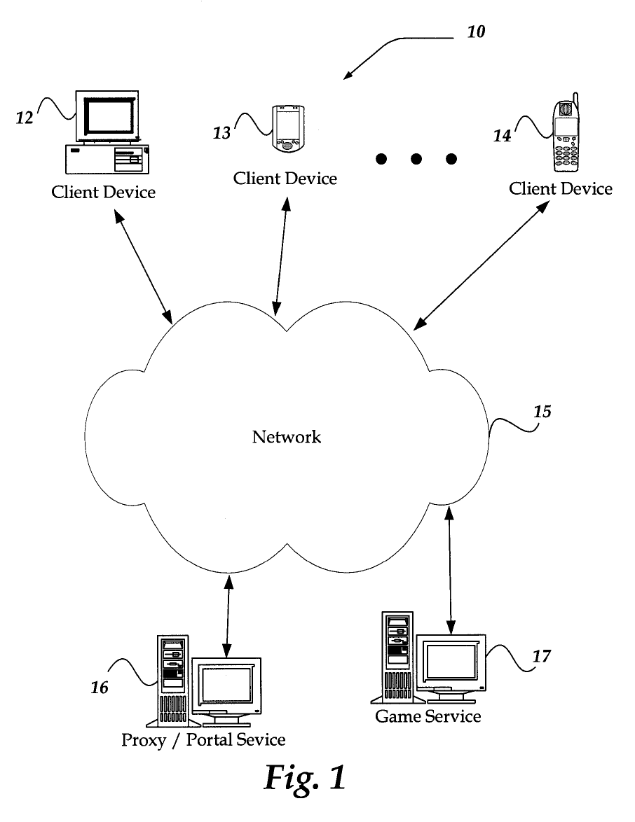

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, a system 10 includes client devices 12-14, a network 15, a proxy service 16 (that may also be a portal service), and a game service 17 that is not directly associated with the proxy service in this embodiment (although the game service may be associated with the proxy service). Network 15 is in communication with and enables communication between each of client devices 12-14, proxy service 16, and game service 17.

Client devices 12-14 may include virtually any computing device capable of receiving and sending a message over a network, such as network 15, to and from another computing device, such as proxy service 16, each other, and the like. The set of such devices may include mobile terminals that are usually considered more specialized devices and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. The set of such devices may also include devices that are usually considered more general purpose devices and typically connect using a wired communications medium such as personal computers, multiprocessor systems, microprocessor-based or programmable consumer electronics, network PCs, and the like. Similarly, client devices 12-14 may be any device that is capable of connecting using a wired or wireless communication medium such as a personal digital assistant (PDA), POCKET PC, wearable computer, and any other device that is equipped to communicate over a wired and/or wireless communication medium.

Each client device within client devices 12-14 includes a user interface that enables a user to control settings, such as presence settings, and to instruct the client device to perform operations. Each client device also includes a communication interface that enables the client device to send and receive messages from another computing device employing the same or a different communication mode, including, but not limited to short message service (SMS) messaging, multi-media message service (MMS) messaging, instant messaging (IM), email, internet relay chat (IRC), Mardam-Bey's internet relay chat (mIRC), Jabber, and the like. Client devices 12-14 may be further configured with a game client program that may run independently or through a browser application that is configured to receive and to send web pages, web-based messages, and the like. The game client program and/or the browser application may be configured to receive and display graphics, text, multimedia, and the like. The browser application may employ virtually any web based language, including, but not limited to a Handheld Device Markup Language (HDML), such as Wireless Markup Language (WML), WMLScript, JavaScript, a Standard Generalized Markup Language (SGML), HyperText Markup Language (HTML), Extensible Markup Language (XML), a wireless application protocol (WAP), and the like.

Network 15 is configured to couple one computing device to another computing device to enable them to communicate. Network 15 is enabled to employ any form of medium for communicating information from one electronic device to another. Also, network 15 may include a wireless interface, such as a cellular network interface, and/or a wired interface, such as an Internet interface, in addition to an interface to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Integrated Services Digital Networks (ISDNs), Digital Subscriber Lines (DSLs), wireless links including satellite links, or other communications links that are equivalent and/or known to those skilled in the art. Furthermore, remote computers and other related electronic devices could be remotely connected to either LANs or WANs via a modem and temporary telephone link. In essence, network 15 includes any communication method by which information may travel between client devices 12-14, proxy service 16, and/or game service 17. Network 15 is constructed for use with various communication protocols including transmission control protocol/internet protocol (TCP/IP), WAP, code division multiple access (CDMA), global system for mobile communications (GSM), and the like.

The media used to transmit information in communication links as described above generally includes any media that can be accessed by a computing device, including conductive media, magnetic media, optical media, air or other carrier wave media, and the like. Computer-readable media may include computer storage media, wired and wireless communication media, or any combination thereof. Additionally, computer-readable media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of further example, communication media includes wireless media such as acoustic, RF, infrared, and other wireless media, and wired media such as twisted pair, coaxial cable, fiber optics, wave guides, and other wired media.

Illustrative Client Environment

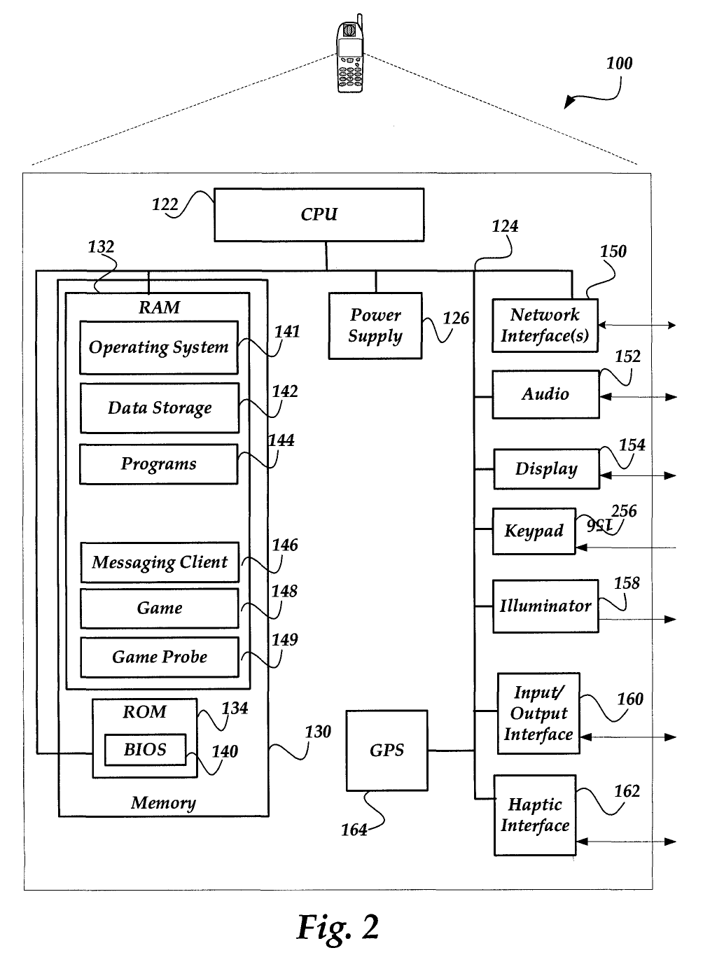

FIG. 2 shows one embodiment of client device 100 that may be included in a system implementing the invention. Client device 100 may include many more or less components than those shown in FIG. 2. However, the components shown are sufficient to disclose an illustrative embodiment for practicing the present invention. As shown in the figure, client device 100 includes a processing unit 122 in communication with a mass memory 130 via a bus 124.

Client device 100 also includes a power supply 126, one or more network interfaces 150, an audio interface 152, a display 154, a keypad 156, an illuminator 158, an input/output interface 160, a haptic interface 162, and an optional global positioning systems (GPS) receiver 164. Power supply 126 provides power to client device 100. A rechargeable or non-rechargeable battery may be used to provide power. The power may also be provided by an external power source, such as an AC adapter or a powered docking cradle that supplements and/or recharges a battery.

Client device 100 may optionally communicate with a base station (not shown), or directly with another computing device. Network interface 150 includes circuitry for coupling client device 100 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, and the like.

Audio interface 152 is arranged to produce and receive audio signals such as the sound of a human voice. For example, audio interface 152 may be coupled to a speaker and microphone (not shown) to enable telecommunication with others and/or generate an audio acknowledgement for some action. Display 154 may be a liquid crystal display (LCD), gas plasma, light emitting diode (LED), or any other type of display used with a computing device. Display 154 may also include a touch sensitive screen arranged to receive input from an object such as a stylus or a digit from a human hand.

Keypad 156 may comprise any input device arranged to receive input from a user. For example, keypad 156 may include a push button numeric dial, or a keyboard. Keypad 156 may also include buttons for inputting commands such as cursor movements, menu selections, instructions associated with selecting and sending images, and the like. Illuminator 158 may provide a status indication and/or provide light. Illuminator 158 may remain active for specific periods of time or in response to events. For example, when illuminator 158 is active, it may backlight the buttons on keypad 156 and stay on while the client device is powered. Also, illuminator 158 may backlight these buttons in various patterns when particular actions are performed, such as dialing another client device. Illuminator 158 may also cause light sources positioned within a transparent or translucent case of the client device to illuminate in response to actions.

Client device 100 also comprises input/output interface 160 for communicating with external devices, such as a headset, or other input or output devices not shown in FIG. 2. Input/output interface 160 can utilize one or more communication technologies, such as USB, infrared, Bluetooth™, and the like. Haptic interface 162 is arranged to provide tactile feedback to a user of the client device. For example, the haptic interface may be employed to vibrate client device 100 in a particular way when another user of a computing device is calling.

Optional GPS transceiver 164 can determine the physical coordinates of client device 100 on the surface of the Earth, which typically outputs a location as latitude and longitude values. GPS transceiver 164 can also employ other geo-positioning mechanisms, including, but not limited to, triangulation, assisted GPS (AGPS), E-OTD, CI, SAI, ETA, BSS and the like, to further determine the physical location of client device 100 on the surface of the Earth. It is understood that under different conditions, GPS transceiver 164 can determine a physical location within millimeters for client device 100; and in other cases, the determined physical location may be less precise, such as within a meter or significantly greater distances.

Mass memory 130 includes a RAM 132, a ROM 134, and other storage means. Mass memory 130 illustrates another example of computer storage media for storage of information such as computer readable instructions, data structures, program modules or other data. Mass memory 130 stores a basic input/output system (“BIOS”) 140 for controlling low-level operation of client device 100. The mass memory also stores an operating system 141 for controlling the operation of client device 100. It will be appreciated that this component may include a specialized client communication operating system such as Windows Mobile™, or the Symbian® operating system, or a general purpose operating system such as a version of UNIX, LINUX™, Window®, or the like. The operating system may include, or interface with a virtual machine module, such as a Java™ virtual machine module that enables control of hardware components and/or operating system operations via Java application programs.

Memory 130 further includes one or more data storage 142, which can be utilized by client device 100 to store, among other things, programs 144 and/or other data. For example, data storage 142 may also be employed to store information that describes various capabilities of client device 100. The information may then be provided to another device based on any of a variety of events, including being sent as part of a header during a communication, sent upon request, and the like.

Programs 144 may include computer executable instructions which, when executed by client device 100, process text, audio, video, and the like. Other examples of application programs include calendars, contact managers, task managers, transcoders, database programs, word processing programs, spreadsheet programs, games, codec programs, and so forth. In addition, mass memory 130 stores a messaging client 146, transmit, receive, and/or otherwise process messages (e.g., SMS, MMS, IM, email, and/or other messages), and enable telecommunication with a server, another user of another client device, and the like. Mass memory 130 may further include a game client 148, providing game execution instructions on client device 100, and/or game communication services with an online game. A game probe 149 may also be included for detecting and/or monitoring game programs on client device 100.

Exemplary Proxy/Portal Server

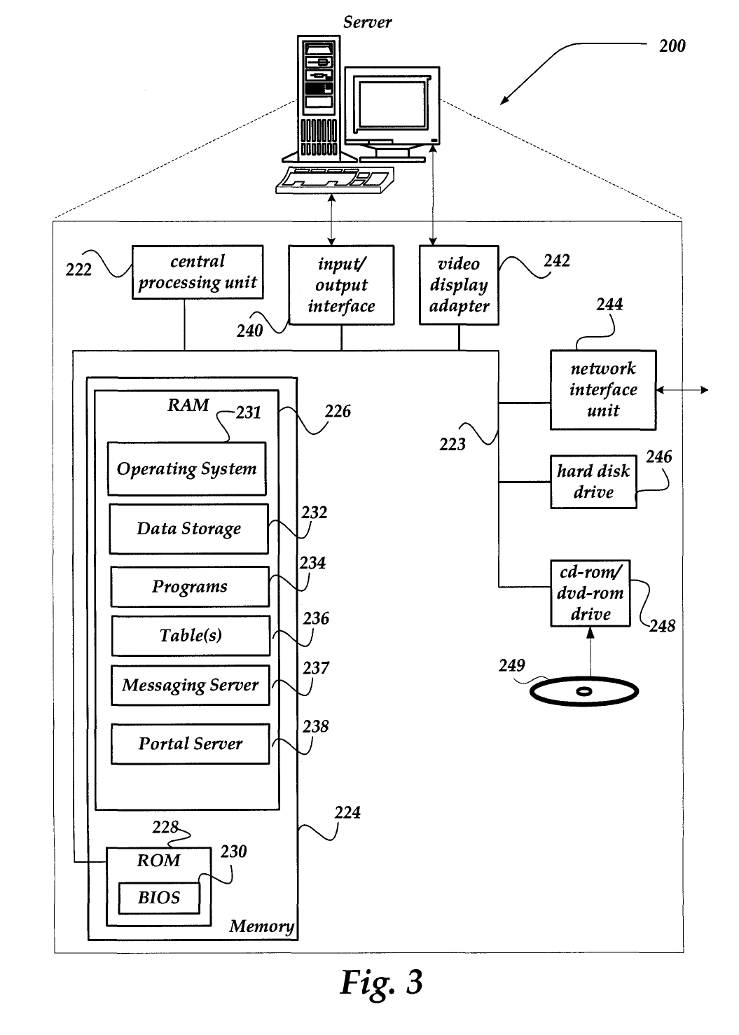

One embodiment of an exemplary proxy server, such as a server device 200, is described in more detail below in conjunction with FIG. 3. Briefly, proxy server device 200 may include any computing device capable of connecting to network 15 to enable a user to communicate with other devices, such as game service 17, and/or other devices. Proxy server device 200 may or may not be combined with, in communication with, or otherwise associated with portal services, such as news services, financial services, messaging services, search services, and the like. Proxy server device 200 may include many more components than those shown. The components shown, however, are sufficient to disclose an illustrative embodiment for practicing the invention. Many of the components of proxy server device 200 may also be duplicated in a server of portal service 16, a server of game service 17, and/or other server devices.

As shown in the figure, client device 200 includes a processing unit 222 in communication with a mass memory 224 via a bus 223. Mass memory 224 generally includes a RAM 226, a ROM 228, and other storage means. Mass memory 224 also illustrates a type of computer-readable media, namely computer storage media. Computer storage media may include volatile and nonvolatile, removable and non-removable media implemented in any method or technology for storage of information such as computer readable instructions, data structures, program modules or other data. Other examples of computer storage media include EEPROM, flash memory or other semiconductor memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 224 stores a basic input/output system (“BIOS”) 230 for controlling low-level operation of proxy server device 200. The mass memory also stores an operating system 231 for controlling the operation of proxy server device 200. It will be appreciated that this component may include a general purpose operating system such as a version of Windows™, UNIX, LINUX™, or the like. The operating system may also include, or interface with a virtual machine module that enables control of hardware components and/or operating system operations via application programs.

Mass memory 224 further includes one or more data storage units 232, which can be utilized by proxy server device 200 to store, among other things, programs 234 and/or other data. Programs 234 may include computer executable instructions which can be executed by client device 200 to implement a WAP or other protocol handler application for transmitting, receiving and otherwise processing communications. Similarly, programs 234 can include an WAPS or other protocol handler application for handling secure connections, such as initiating communication with an external application in a secure fashion. Other examples of application programs include schedulers, calendars, web services, transcoders, database programs, word processing programs, spreadsheet programs, and so forth. Accordingly, programs 234 can process data communications, web pages, audio, video, and enable telecommunication with electronic devices.

In addition, mass memory 224 may store one or more programs for messaging, gaming and/or other applications. A messaging server module 237 may include computer executable instructions, which may be run under control of operating system 231 to enable SMS, MMS, instant messaging, e-mail, and/or other messaging services. Similarly, proxy server device 200 may provide routing, access control, and/or other server-side messaging services. Proxy server device 200 may further include a portal server 38, which provides other portal services, including shopping services, social networking services, mapping services, and the like. A server device configured much like proxy server device 200 (and/or proxy server device 200 itself) may include a monitoring module (not shown) that monitors activity of online game services. The same server, or a different server may include or communicate with a data warehouse module (not shown) that collects, analyzes, and stores aggregated information regarding the online game services.

Proxy server device 200 also includes an input/output interface 240 for communicating with input/output devices such as a keyboard, mouse, wheel, joy stick, rocker switches, keypad, printer, scanner, and/or other input devices not specifically shown in FIG. 3. A user of proxy server device 200 can use input/output devices to interact with a user interface that may be separate or integrated with operating system 231 and/or programs 234-238. Interaction with the user interface includes visual interaction via a display, and a video display adapter 242.

Proxy server device 200 may include a removable media drive 244 and/or a permanent media drive 246 for computer-readable storage media. Removable media drive 244 can comprise one or more of an optical disc drive, a floppy disk drive, and/or a tape drive. Permanent or removable storage media may include volatile, nonvolatile, removable, and non-removable media implemented in any method or technology for storage of information, such as computer readable instructions, data structures, program modules, or other data. Examples of computer storage media include a CD-ROM 249, digital versatile disks (DVD) or other optical storage, magnetic cassettes, magnetic tape, magnetic disk storage or other magnetic storage devices, RAM, ROM, EEPROM, flash memory or other memory technology, or any other medium which can be used to store the desired information and which can be accessed by a computing device.

Via a network communication interface unit 244, proxy server device 200 can communicate with a wide area network such as the Internet, a local area network, a wired telephone network, a cellular telephone network, and/or some other communications network, such as network 15 in FIG. 1. Network communication interface unit 244 is sometimes known as a transceiver, transceiving device, network interface card (NIC), and the like.

Exemplary Program Detection and Notification

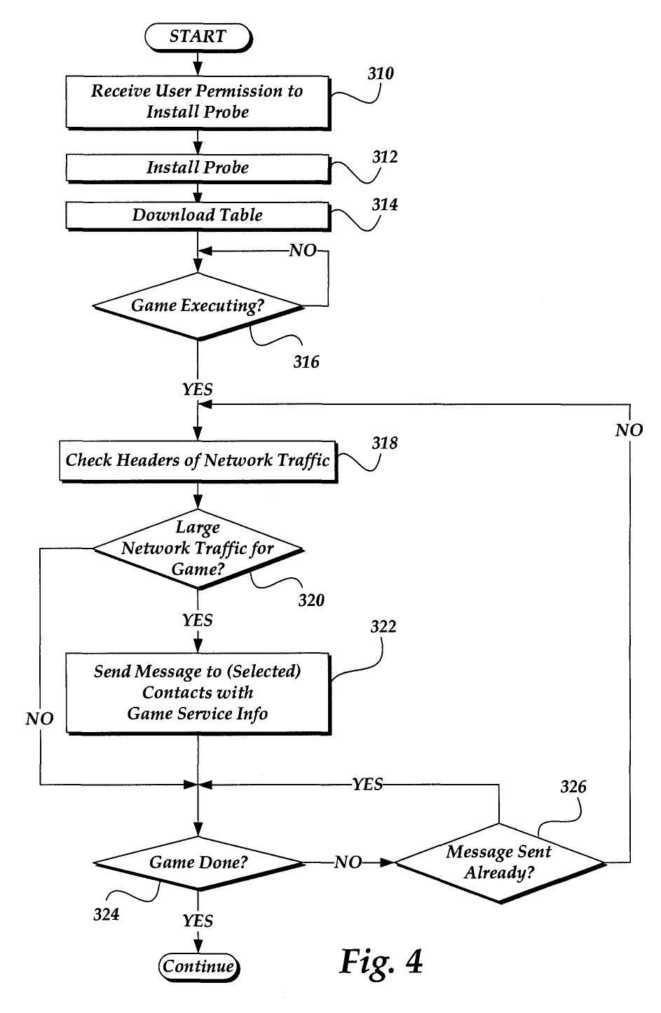

FIG. 4 is a flow diagram illustrating exemplary logic for one embodiment of a game probe on a client device, such as mobile client device 100, to detect execution of a game program and notify another client. At an operation 310, a client device receives permission to install the game probe. Permission may be provided when the client requests the game probe, when the game probe initiates its installation process, and/or at another suitable time. At an operation 312, the game probe is installed on the client device. The game probe contacts the games monitor and downloads a current table of available online game services at an operation 314.

At a decision operation 316, the game probe monitors an operating system process list for filenames of predefined executable files corresponding to games and/or other application programs that are listed in the table. If the game probe does not detect one the predefined executable files, the game probe continues to monitor the process list. The game probe may wait for predefined or selectable intervals, such as every 15 seconds, to check for any of the predefined executable files. Once the game probe detects a predefined executable file in the process list, the game probe checks headers of communication traffic associated with the predefined executable file, at an operation 318. The game probe may check to see whether most the communication traffic is with the same game server, with the same proxy server that is associated with game services, on the same port, and/or other communication characteristics. At a decision operation 320, the game probe determines whether a large amount of communication traffic is associated with the predefined executable file. For example, the game probe may detect whether a certain number of user datagram protocol (UDP) messages have been exchanged with the same game server or same proxy server within a specific time period. The number of messages and time period are generally provided in the table. However, the threshold number of messages and time period may depend on communication optimizations for each game, game servers, and/or other aspects.

If the communication traffic indicates that the client is communicating with an online game service and/or with the proxy server, the game probe instructs the messenger client to send a message, such as an SMS or an instant message to one or more contacts, at an operation 322. The client user may preselect contacts to which a message should be sent and/or predefine other limitations on sending messages related to execution of the predefined program(s). The message may include information associated with the game service, so that contacts may communicate with the same game service. This provides an automated way to invite friends to participate in an online game and/or other services. The message may be sent directly to contacts based on information stored on the client. Alternatively, or in addition, the message may be communicated to the proxy server or a portal service which may distribute the message to other clients based on an address book and/or other contact information stored by the proxy server or portal service. Conversely, if the communication traffic indicates that the client is not communicating with an online game service or proxy server, but instead may be playing the game only locally, no message is sent.

At a decision operation 324, the game probe detects whether the predefined executable file is still executing as indicated by the process list. If the game is still executing, the game probe determines, at a decision operation 326, whether a messages already been sent. If a message has already been sent, the game probe continues to monitor the process list to detect delisting of the predefined executable file. However, if a message was not previously sent, control returns to operation 318 to continue to monitor communication traffic related to the predefined executable file. If the game has ended, the predefined executable file will no longer be listed, and the game probe can return to detecting and/or monitoring any other predefined executable files.

Exemplary Proxy Server Operation

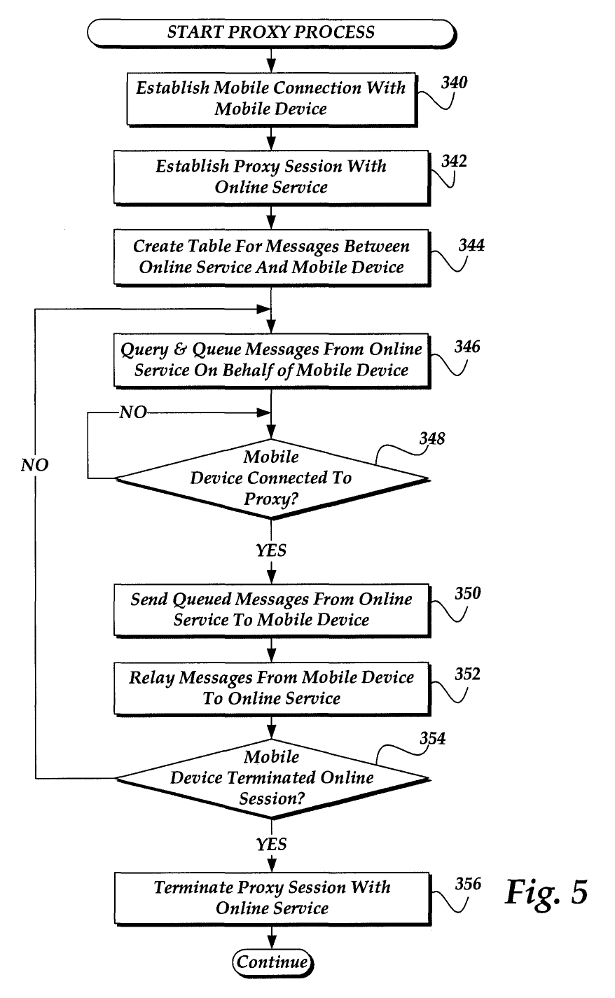

FIG. 5 is a flow diagram illustrating exemplary logic for a proxy server. This exemplary embodiment is described in terms of a proxy server managing communication between an intermittently communicating mobile device and an online game service, although the invention is not so limited. Any client device may communicate intermittently, depending on the device and/or communication network. Intermittent communication devices may include cell phones, PDAs, hand-held game devices, laptops, general purpose computers, or any other device that may experience discontinuous communications with an online service, such as the online game service. Intermittent communication may result from complete loss of contact or from a degradation in communication that falls below a threshold.

At an operation 340, the proxy server and the mobile device establish initial communication. The mobile device may directly request a communication session with the proxy server. Alternatively, the online game service or a portal service may relay a request from the mobile device to the proxy server. For example, the mobile device may receive a notification from an online portal that a friend is participating in the online game service. The mobile device may then select a link in the notification, requesting communication with the same online game service. The online game service or the online portal may receive the request, determine that the request is from a potential or confirmed intermittent communication device, and route the request to the proxy server. In any case, the mobile device requests a session with the online game service. Communication between the mobile device and the proxy server may or may not remain persistently active to establish the game session and/or throughout the game session.

At an operation 342, the proxy server establishes proxy communication with the online game service on behalf of the mobile device. This proxy communication will remain active throughout the game session. Many online game services expect the client device to remain in active communication throughout the game session. If a session is interrupted, the game service may interpret the interruption as a decision by the client device to terminate the game session. The proxy server maintains communication with the online game service to maintain the game session for intermittent communication devices, such as mobile devices, that may not be able to maintain the game session.

To accommodate intermittent communication, the proxy server also maintains a queue of messages and/or other information between the mobile device and the online game service. To maintain the queue, the proxy server creates a message table at an operation 344. The message table includes a unique identifier of the mobile device, which may be a telephone number, a mobile identification number (MIN), and/or the like. The unique identifier may also be encrypted with a hashing function that utilizes a time of day, a random number, other seed, or a combination for security. The message table also includes a connection identifier that corresponds to the communication session between the proxy server and the online game service. The table also includes one or more queues of messages awaiting deliver between the online game service and the mobile device. The messages are generally input commands and/or data from the mobile device for the online game and instructions and/or data from the online game to the client game program. The proxy server may use a single message table for each mobile device or a consolidated table for all mobile devices communicating with the proxy server. A sample message table is illustrated in Table 1.

TABLE 1
Sample Message Table

| | Game Service | | |
|---|---|---|---|
| | Connection | | |
| Mobile Device | (e.g. port, | Messages From | Messages From |
| Unique ID | session ID, etc.) | Game Service | Mobile Device |
| 12345 | Port 80, | Target Destroyed | Move Left 4 |
| | Session 321 | (Display explosion) | |
| | | Display New Target | |

At an operation 346, the proxy server queries the online game service for messages, instructions, or other data that are intended for the mobile client device. The proxy server may temporarily queue, buffer, or otherwise store the data from the online game service until, or unless the mobile device is currently in communication with the proxy server. At a decision operation 348, the proxy server determines whether the mobile device is currently in communication with the proxy server. If communication with the mobile device is interrupted, or substantially degraded, the proxy server waits for the mobile device to reconnect or otherwise resume sufficient communication with the proxy server. The proxy server may limit the wait time to a predefined period, after which the proxy server may end the game session with the online game service.

If the mobile device is currently in communication with the proxy server, the proxy server sends messages from the online game service to the mobile device, at an operation 350. Similarly, at an operation 352, the proxy server relays any messages from the mobile device to the online game service. At a decision operation 354, the proxy server determines whether the mobile device terminated the session with the online game service by logging out, turning off the mobile device, or otherwise indicating a desire to terminate communications. If the mobile device terminates communication, the proxy server terminates the persistent communication session with the online game session and continues with other mobile devices. Otherwise, control returns to operation 346 where the proxy server awaits further messages from the online game service.

The above specification, examples, and data provide a complete description of the manufacture and use of the composition of the invention. However other embodiments will be clear to one skilled in the art. For example, the proxy server may be used to maintain communication with the online portal service, or any other service. The proxy server may also be used to relay messages from the mobile device to the messaging server that notifies other contacts that the mobile device is participating in the online service. Also, the client probe on the mobile device may detect any type of predetermined process being executed on the mobile device, besides games, and notify other clients. Since many embodiments of the invention can be made without departing from the spirit and scope of the invention, the invention resides in the claims hereinafter appended.

What is claimed as new and desired to be protected by Letters Patent of the United States is:

1. A method for managing communication between an intermittent communication device and an online service, comprising:
receiving a request for communication between the intermittent communication device and the online service;
establishing a proxy communication session with the online service;
receiving from the online service, a message intended for the intermittent communication device;
establishing temporary communication with the intermittent communication device; and
sending the message to the intermittent communication device.

2. The method of claim 1, wherein the intermittent communication device comprises at least one of the following; a cellular telephone, a personal digital assistant, and a mobile game device.

3. The method of claim 1, wherein the request is received from an online portal service which is in communication with the intermittent communication device.

4. The method of claim 1, wherein the request is received in response to a notification that another client device is communicating with the online service.

5. The method of claim 4, wherein the notification is initiated by a game probe that detects execution of a predefined file on the other client device.

6. The method of claim 1, further comprising storing the message until the intermittent communication device requests the temporary communication.

7. The method of claim 1, wherein the proxy communication session remains active until one of:
receiving an instruction from the intermittent communication device to terminate the proxy communication session; and
a predefined period has elapsed since communicating with the intermittent communication device.

8. The method of claim 1, wherein the online service comprises a game service.

9. The method of claim 1, further comprising:
receiving a client message from the intermittent communication device, wherein the client message is intended for the online service; and
sending the client message to the online service.

10. A computer readable medium, comprising executable instructions for performing actions, including:
receiving a request for communication between the intermittent communication device and the online service;
establishing a proxy communication session with the online service;
receiving from the online service, a message intended for the intermittent communication device;
establishing temporary communication with the intermittent communication device; and
sending the message to the intermittent communication device.

11. A modulated data signal for communicating data over a network, the modulated data signal comprising instructions that enable a computing device to perform the actions of:
receiving a request for communication between the intermittent communication device and the online service;
establishing a proxy communication session with the online service;
receiving from the online service, a message intended for the intermittent communication device;
establishing temporary communication with the intermittent communication device; and
sending the message to the intermittent communication device.

12. A server device for managing communication between an intermittent communication device and an online service, comprising:
a communication interface in communication with the intermittent communication device and the online service;
a memory for storing instructions and data; and
a processor in communication with the communication interface and with the memory, wherein the processor performs actions based at least in part on the stored instructions, including:
receiving a request for communication between the intermittent communication device and the online service;
establishing a proxy communication session with the online service;
receiving from the online service, a message intended for the intermittent communication device;
establishing temporary communication with the intermittent communication device; and
sending the message to the intermittent communication device.

13. The server device of claim 12, wherein the communication interface is further in communication with an online portal service and the request is received from the online portal service which is also in communication with the intermittent communication device.

14. The server device of claim 12, wherein the request is received in response to a notification that another client device is communicating with the online service.

15. The server device of claim 12, wherein the instructions causes the processor to further perform the actions of:
associating the message with a unique identifier that represents the intermittent communication device;
storing the message and the unique identifier; and
detecting establishment of the temporary communication with the intermittent communication device.

16. The server device of claim 12, wherein the proxy communication session remains active until one of:
receiving an instruction from the intermittent communication device to terminate the proxy communication session; and
a predefined period has elapsed since communicating with the intermittent communication device.

17. The server device of claim 12, wherein the online service comprises a game service.

18. The server device of claim 12, wherein the instructions causes the processor to further perform the actions of:
receiving a client message from the intermittent communication device, wherein the client message is intended for the online service; and
sending the client message to the online service.

19. A client device for communicating with an online service, comprising:
a communication interface in communication with a proxy server;
a memory for storing instructions; and
a processor in communication with the communication interface and with the memory, wherein the processor performs actions based at least in part on the stored instructions, including:
sending a request for communication with the online service;
establishing temporary communication with the proxy server; and
receiving message from the proxy server that was received by the proxy server from the online service, wherein the proxy server has a proxy communication session with the online service.

20. The client device of claim 19, wherein the client device comprises at least one of the following; a cellular telephone, a personal digital assistant, and a mobile game device.
